(19) United States
(12) Patent Application Publication
(10) Pub. No.: US 2021/0286114 A1
(43) Pub. Date: Sep. 16, 2021

(54) ASYMMETRIC TRANSMISSION STRUCTURE AND SEMICONDUCTOR OPTICAL DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Nanfang JIA, Beijing (CN); Jian ZHOU, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 17/194,598

(22) Filed: Mar. 8, 2021

(30) Foreign Application Priority Data
Mar. 12, 2020 (CN) 202020307601.8

(51) Int. Cl. G02B 5/18; H04B 10/50

(52) U.S. Cl. CPC G02B 5/1866; H04B 10/501

(57) ABSTRACT

The present disclosure provides an asymmetric transmission structure and a semiconductor optical device. The asymmetric transmission structure includes a transparent basal layer and a grating layer arranged at a side of the transparent basal layer. The grating layer includes a plurality of structural members arranged periodically and spaced apart from each other in a direction parallel to the transparent basal layer, each structural member is provided with a first surface and a second surface, the second surface is attached to the transparent basal layer, and an area of the first surface is not larger than an area of the second surface.

### CROSS-REFERENCE TO RELATED APPLICATION

This application claims priority to Chinese Patent Application No. 202020307601.8 filed on Mar. 12, 2020, which is incorporated herein by reference in its entirety.

### TECHNICAL FIELD

The present disclosure relates to the field of optical device, in particular to an asymmetric transmission structure and a semiconductor optical device.

### BACKGROUND

Asymmetric light transmission (ALT) refers to such a phenomenon that light has different transmittances when it passes through a device structure in forward and backward directions. The ALT may be potentially applied to the development of next-generation all-optical computing & processing device and system, as well as automobiles, decorations and military science.

### SUMMARY

In a first aspect, the present disclosure provides in some embodiments an asymmetric transmission structure, including a transparent basal layer and a grating layer arranged at a side of the transparent basal layer. The grating layer includes a plurality of structural members arranged periodically and spaced apart from each other in a direction parallel to the transparent basal layer, each structural member is provided with a first surface and a second surface, the second surface is attached to the transparent basal layer, and an area of the first surface is not larger than an area of the second surface.

In a second aspect, the present disclosure further provides in some embodiments a semiconductor optical device including the above-mentioned asymmetric transmission structure.

The additional aspects and advantages of the present disclosure will be given or may become apparent in the following description, or may be understood through the implementation of the present disclosure.

### BRIEF DESCRIPTION OF THE DRAWINGS

The above and/or additional aspects and advantages of the present disclosure may become apparent and easily understandable in the following description in conjunction with the drawings and the embodiments. In these drawings,

FIG. 1 is a schematic view showing an asymmetric transmission structure according to one embodiment of the present disclosure;

FIG. 2 is a top view of the asymmetric transmission structure according to one embodiment of the present disclosure;

FIG. 3 is another top view of the asymmetric transmission structure according to one embodiment of the present disclosure; and

FIG. 4 is a diagram of a simulation result of the asymmetric transmission structure according to one embodiment of the present disclosure.

### DETAILED DESCRIPTION

The present disclosure will be described hereinafter in conjunction with the embodiments and the drawings. Identical or similar reference numbers in the drawings represent an identical or similar element or elements having an identical or similar function. In addition, the detailed description about any known technology will be omitted when it is unnecessary to the features in the present disclosure. The following embodiments are for illustrative purposes only, but shall not be used to limit the scope of the present disclosure.

It should be appreciated that, unless otherwise defined, all terms used herein (including technical or scientific terms) shall have the common meaning understood by a person of ordinary skills. It should be further appreciated that, any term defined in a commonly-used dictionary shall be understood as having the meaning in conformity with that in the related art, but shall not be interpreted idealistically and extremely.

Unless otherwise defined, such words as “a”, “one”, “the” or “said” are merely used to represent the existence of at least one member, rather than to limit the number thereof. Such words as “include” or “including” intend to indicate that there are the features, integers, steps, operations, elements and/or assemblies, without excluding the existence or addition of one or more other features, integers, steps, operations, elements, assemblies and/or combinations thereof. In the case that one element is connected or coupled to another element, it may be directly connected or coupled to the other element, or an intermediate element may be arranged therebetween. At this time, the element may be connected or coupled to the other element in a wireless or wired manner. In addition, the expression “and/or” is used to indicate the existence of all or any one of one or more of listed items, or combinations thereof.

Usually, a conventional system for implementing the ALT is made of a reciprocal material or element.

Currently, an element for implementing the ALT has a relatively complex structure. Due to the limitation of materials and structure, it is difficult for a process for manufacturing the element to be compatible with a process for manufacturing a semiconductor and a display panel. In addition, the element has a tiny structure, and machining accuracy is highly demanded, so the compatibility with the process for manufacturing the semiconductor and the display panel may be further limited. Moreover, in the related art, it is difficult to provide the element with a large bandwidth, and few elements may operate at a visible light band. Further, polarization dependency occurs for most of the elements.

In the related art, for an optical nonreciprocal element capable of implementing the ALT, it is able to allow any optical mode in one direction but prohibit the optical mode in the other direction. However, a polarization characteristic of light itself is required for the optical nonreciprocal element, so it is difficult to apply the element to the asymmetric transmission of visible light. In addition, for example, an optical nonreciprocal element based on a magneto-optic Faraday effect has a complex structure due to the existence of a Faraday rotator, a prism, a polarizer and a polarization analyzer, and it is difficult to integrate these members on a semiconductor substrate through a Complementary Metal Oxide Semiconductor (CMOS) process, leading to relatively difficult machining and manufacture.

An object of the present disclosure is to provide an asymmetric transmission structure and a semiconductor optical device, so as to solve the problems in the related art where it is difficult for a process for manufacturing the asymmetric transmission element to be compatible with the process for manufacturing the semiconductor and the display panel and it is difficult for the asymmetric transmission element to normally operate at the visible light band.

The technical schemes in the present disclosure and how to solve the above problems will be described hereinafter in more details in conjunction with the embodiments.

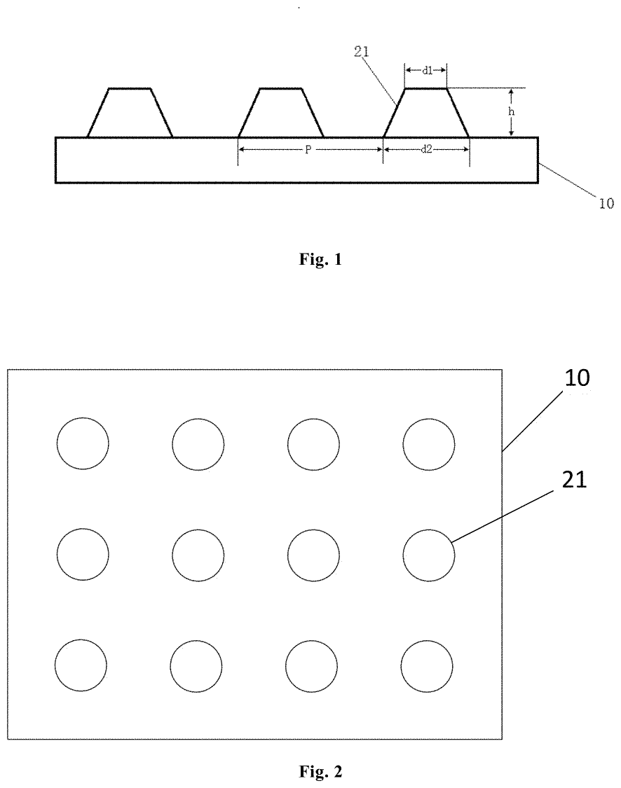

The present disclosure provides in some embodiments an asymmetric transmission structure which, as shown in FIG. 1, includes a transparent basal layer 10 and a grating layer arranged at a side of the transparent basal layer 10. The grating layer includes a plurality of structural members 21 arranged periodically and spaced apart from each other in a direction parallel to the transparent basal layer 10, each structural member 21 is provided with a first surface and a second surface, the second surface is attached to the transparent basal layer 10, and an area of the first surface is not larger than an area of the second surface.

It should be appreciated that, a direction in which light enters the grating layer where the structural member 21 is located and exits from the transparent basal layer 10 is a forward transmission direction, and a direction in which the light enters the transparent basal layer 10 and exits from the grating layer where the structural member 21 is located is a backward transmission direction.

In the embodiments of the present disclosure, the structural members 21 may include at least one kind of cylindrical structural members and truncated cone-like structural members.

Due to the structural member 21 with a high level of symmetry, it is able to achieve the asymmetric transmission of natural visible light. In addition, a ratio of a transmittance in the forward transmission direction to a transmittance in the backward transmission direction is large, and this ratio is called as a contrast ratio. Hence, according to the asymmetric transmission structure in the embodiments of the present disclosure, it is able to efficiently achieve the ALT at a full visible light band.

It should be appreciated that, the more the symmetry planes of a structure, the higher level of symmetry, so the structure with more symmetry planes may be called as a structure with a high level of symmetry relative to a structure with fewer symmetry planes. The cylindrical structural member and the truncated-cone-like structural member each has innumerable symmetry planes, so the structural member 21 of the asymmetric transmission structure is a structure with a high level of symmetry. In addition, due to the high level of symmetry, it is able for the structural member 21 to achieve the asymmetric transmission of the natural visible light (non-polarized light).

According to the embodiments of the present disclosure, the asymmetric transmission structure may include the transparent basal layer and the grating layer arranged at the side of the transparent basal layer. The grating layer may include the plurality of structural members arranged periodically and spaced apart from each other in the direction parallel to the transparent basal layer, each structural member is provided with the first surface and the second surface, the second surface is attached to the transparent basal layer, and the area of the first surface is not larger than the area of the second surface. The asymmetric transmission structure in the embodiments of the present disclosure is simple, and a process for manufacturing the asymmetric transmission structure is compatible with a CMOS process, e.g., the asymmetric transmission structure may be manufactured through nanoimprinting in combination with an etching process for a semiconductor display product. As a result, it is able to facilitate the integration and extension of the asymmetric transmission structure, and reduce the manufacture cost.

In addition, the structural members may include at least one kind of cylindrical structural members and truncated-cone-like structural members, and the cylindrical structural member and the truncated-cone-like structure member may each include a plurality of symmetry planes and a plurality of symmetry centers, i.e., they may be structural members with a high level of symmetry. Hence, it is able for the structural members to be adapted to polarized light and non-polarized light and operate at the full visible light band, thereby to achieve the asymmetric transmission of the visible light.

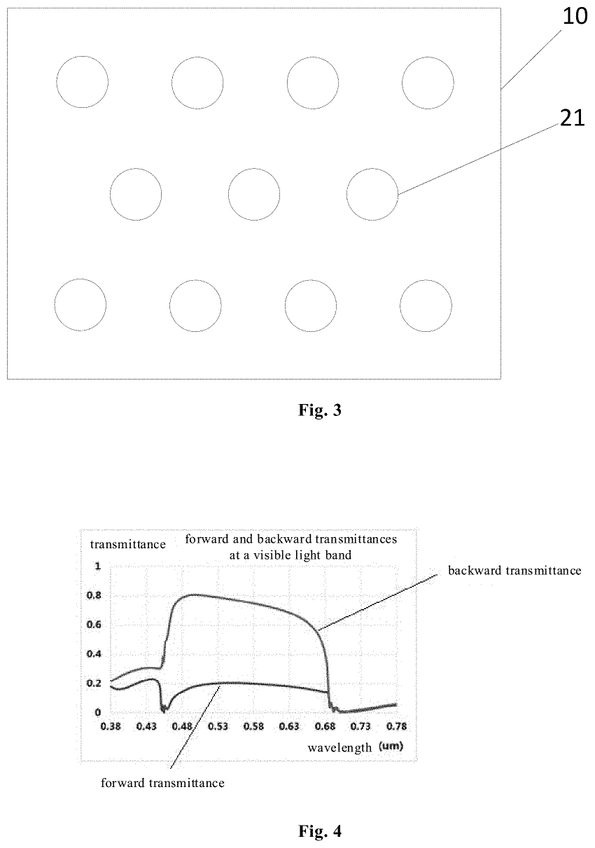

In a possible embodiment of the present disclosure, as shown in FIGS. 2-3, the structural members 21 may be arranged periodically at the side of the transparent basal layer 10 in the direction parallel to the transparent basal layer 10.

To be specific, in the asymmetric transmission structure in FIG. 2, the plurality of structural members 21 may be periodically arranged at the side of the transparent basal layer 10 in a two-dimensional simple-square Bravais lattice. In the asymmetric transmission structure in FIG. 3, the plurality of structural members 21 may be periodically arranged at the side of the transparent basal layer 10 in a two-dimensional simple-hexagon Bravais lattice.

It should be appreciated that, in a same asymmetric transmission structure, the arrangement of the structural members 21 may not be limited to one of the two-dimensional simple-square Bravais lattice and the two-dimensional simple-hexagon Bravais lattice, and the structural members 21 may also be periodically arranged at a same side of the transparent basal layer 10 in the two Bravais lattices. In addition, the arrangement of the structural members 21 may not be limited to the two forms in FIGS. 2 and 3 either, and any other arrangement form of the structural members 21 may be determined according to the practical need.

In some embodiments of the present disclosure, the two-dimensional simple-square Bravais lattice belongs to one of point groups C₄ and C₄ᵥ.

In some embodiments of the present disclosure, the two-dimensional simple-hexagon Bravais lattice belongs to one of point groups C₃, C₃ᵥ, C₆ and C₆ᵥ.

The point group to which the two-dimensional simple-hexagon Bravais lattice may be used to describe symmetry of the two-dimensional simple-hexagon Bravais lattice. Taking C₃ as an example, it represents that a pattern acquired after rotating an original two-dimensional simple-hexagon Bravais lattice about a central axis by 360°/3=120° coincides with the original two-dimensional simple-hexagon Bravais lattice. When the Bravais lattice belongs to more point groups, it may have a higher level of symmetry.

It should be appreciated that, through the plurality of periodically-arranged structural members 21 of the grating layer, it is able to provide the grating layer with a higher level of symmetry, thereby to ensure the operation efficiency of the asymmetric transmission structure at the full visible light band and provide the asymmetric transmission structure with a higher contrast ratio at the full visible light band. In addition, through the periodically-arranged structural members 21, it is able to provide the asymmetric transmission structure with a simple structure and facilitate the machining thereof, thereby to improve the yield of the asymmetric transmission structure.

In a possible embodiment of the present disclosure, an arrangement period P of the structural members 21 may range from 300 nm to 1000 nm, with the end points inclusive. It should be appreciated that, the arrangement period P may refer to a sum of a diameter d2 of the second surface of each structural member 21 and a distance between two adjacent structural members 21.

Further, the natural visible light has a wavelength of 380 nm to 780 nm. In order to further provide the asymmetric transmission structure with a higher contrast ratio at the full visible light band, in a possible embodiment of the present disclosure, the arrangement period P may range from 500 nm to 700 nm, with the two end points inclusive.

It should be appreciated that, as compared with the asymmetric transmission structure in FIG. 2 whose the plurality of structural members 21 is arranged in the two-dimensional simple-square Bravais lattice, the asymmetric transmission structure in FIG. 3 whose the plurality of structural members 21 is arranged in the two-dimensional simple-hexagon Bravais lattice may have a higher contrast ratio. For the structural members 21 arranged in the two-dimensional simple-hexagon Bravais lattice, an equal distance may be provided between any two adjacent structural members 21, so the arrangement period may be more stable, and thereby the grating layer may have a higher level of symmetry.

In a possible embodiment of the present disclosure, the transparent basal layer 10 in the asymmetric transmission structure may be transparent to the visible light, and each structural member 21 may be nontransparent to the visible light.

In a possible embodiment of the present disclosure, each structural member 21 may be made of a metal material, e.g., gold, silver or aluminum, or a combination thereof.

It should be appreciated that, when the structural member 21 is made of the metal material, Surface Plasmon Polaritons (SSPs) may be formed between the structural member 21 and the transparent basal layer 10, so as to allow the light to pass through the grating layer in a better manner and then enter the transparent basal layer 10, and improve the transmittance of the asymmetric transmission structure in the forward transmission direction, thereby to further improve the contrast ratio, and ensure the asymmetric transmission efficiency of the asymmetric transmission structure at the full visible light band.

In a possible embodiment of the present disclosure, each structural member 21 may be a truncated-cone-like structural member, a diameter d1 of the first surface and a diameter d2 of the second surface of the structural member 21 may each range from 0 nm to 800 nm, with the end point 800 nm inclusive, and a shortest distance h between a center of the first surface and a center of the second surface may range from 0 nm to 500 nm, with the end point 500 nm inclusive.

Further, the diameter d1 of the first surface of the structural member 21 may range from 100 nm to 300 nm, with the end points inclusive, the diameter d2 of the second surface of the structural member may range from 200 nm to 450 nm, with the end points inclusive, and the shortest distance h between the center of the first surface and the center of the second center may range from 100 nm to 200 nm, with the end points inclusive.

It should be appreciated that, the natural visible light has the wavelength of 380 nm to 780 nm. In order to further provide the asymmetric transmission structure with a higher contrast ratio at the full visible light band, it is necessary to limit a height of the structural member 21, i.e., to limit the shortest distance h between the center of the first surface and the center of the second surface within an appropriate range, so as to prevent the transmittance of the asymmetric transmission structure in the forward transmission direction from being adversely affected when the structural member 21 is too high.

In addition, it is necessary to limit the diameter d1 of the first surface and the diameter d2 of the second surface of the structural member 21 within an appropriate range, so as to enable the asymmetric transmission structure to operate normally at the full visible light band.

In a possible embodiment of the present disclosure, a refractive index of the transparent basal layer 10 of the asymmetric transmission structure may range from 1.4 to 2.0.

The transparent basal layer 10 may be made of a commonly-used transparent medium, e.g., polycarbonate (PC), polyethylene terephthalate (PET), polyimide (PI) or glass, as long as its refractive index ranges from 1.4 to 2.0.

The forward transmittance and the backward transmittance of the asymmetric transmission structure in the embodiments of the present disclosure at the visible light band will be simulated in a model simulation manner. FIG. 4 is a diagram showing test results of the asymmetric transmission structure in FIG. 1.

Structure parameters of the asymmetric transmission structure will be given as follows.

1) Grating layer: d1=200 nm, d2=300 nm, h=125 nm, and the structural member 21 is made of aluminum (Al).

2) Transparent basal layer: it is made of glass having a refractive index of 1.52.

3) Type of light source: plane wave, with a light source area of x=600 nm and y=600 nm.

4) Size of simulation area: x′=600 nm, y′=600 nm, and z=2.5 μm.

5) The structural members 21 are arranged in the two-dimensional simple-square Bravais lattice.

Values of x, y, x′ and y′ may each be one arrangement period. Because mainly the metal layer, an interface between the metal layer and air and an interface between the metal layer and the transparent basal layer in the asymmetric transmission structure take effect, the simulation area in a z-axis direction may be an area including the entire metal layer and a range slightly greater than one and a half wavelengths above and below the metal layer. Thus, the simulation area in the z-axis direction may be slightly greater than a sum of a thickness of the metal layer, one and a half wavelengths above the metal layer, and one and a half wavelengths below the metal layer. This is because, when the simulation area is too large, a simulation time may be too long.

In FIG. 4, an x-axis represents the wavelength in unit of μm, a y-axis represents the transmittance. Within a range between 0.38 μm and 0.68 μm, a curve above represents the (average) forward transmittance, and a curve below represents the (average) backward transmittance. As shown in FIG. 4, within the visible light band of 460 nm to 660 nm, for the asymmetric transmission structure in the embodiments of the present disclosure, the average forward transmittance (T_{forward}) is more than 70%, while the average backward transmittance (T_{backward}) is less than 20%. At this time, the contrast ratio may be calculated using the following formula CR(dB)=10*log10(T_{forward}/T_{backward}) (1). Through calculation, the average contrast ratio of the asymmetric transmission structure in the embodiments of the present disclosure may be about 5.44 dB.

It should be appreciated that, (1) in the forward transmission and backward transmission of the visible light, background media and background refractive indices of a diffraction space may be different.

In the forward transmission, the background medium of the diffraction space may be air with a refractive index of 1.0, and in the backward transmission, the background medium of the diffraction space may be a glass dielectric medium with a refractive index of 1.52.

In the forward transmission, more diffraction modes may be allowed, and in the backward transmission, fewer diffraction modes may be allowed.

In addition, based on a calculation method of the diffraction efficiency, because of the different refractive indices of the background media of the diffraction space, the diffraction efficiency in the forward transmission may be greater than that in the backward transmission.

(2) In the forward transmission, an SPPs transmission mode may be formed at an interface between the structural member 21 made of metal and the transparent basal layer 10 made of glass, so the light may pass through the interface in a better manner. In the backward transmission, an evanescent mode may be excited at an interface between the structural member 21 made of metal and air, and very serious attenuation may occur for the light in the diffraction space. In addition, a transmission distance may be very short, usually dozens of nanometers, so less light may be allowed to pass through the interface in the backward direction. In this regard, it is able to improve an asymmetric transmission effect.

Based on a same inventive concept, the present disclosure provides in some embodiments a semiconductor optical device including the above-mentioned asymmetric transmission structure.

The present disclosure at least has the following beneficial effects.

According to the embodiments of the present disclosure, the asymmetric transmission structure may include the transparent basal layer and the grating layer arranged at the side of the transparent basal layer. The grating layer may include the plurality of structural members arranged periodically and spaced apart from each other in the direction parallel to the transparent basal layer, each structural member is provided with the first surface and the second surface, the second surface is attached to the transparent basal layer, and the area of the first surface is not larger than the area of the second surface. As compared with an asymmetric transmission device in the related art, the asymmetric transmission structure in the embodiments of the present disclosure has a simple structure, and a material of the grating layer is suitable for a CMOS process, i.e., a process for manufacturing the asymmetric transmission structure may be compatible with the CMOS process, so it is able to facilitate the integration and extension of the asymmetric transmission structure, and reduce the manufacture cost.

In addition, the area of the first surface of the structural member may be not greater than the area of the second surface connected to the transparent basal layer, so it is able for the asymmetric transmission structure to be adapted to polarized light and non-polarized light and operate at the full visible light band, thereby to achieve the asymmetric transmission of the visible light.

In the above description, it should be appreciated that, such words as “in the middle of”, “on/above”, “under/below”, “front”, “back”, “left”, “right”, “vertical”, “horizontal”, “top”, “bottom”, “inside” and “outside” may be used to indicate directions or positions as viewed in the drawings, and they are merely used to facilitate the description in the present disclosure, rather than to indicate or imply that a device or member must be arranged or operated at a specific position.

In addition, such words as “first” and “second” are merely for illustrative purposes, rather than to implicitly or explicitly indicate the number of the defined technical features. In this regard, the technical features defined with such words as “first” and “second” may implicitly or explicitly include one or more technical features. Further, such a phrase as “a plurality of” is used to indicate that there are at least two, e.g., two or three, components, unless otherwise specified.

Unless otherwise specified, such words as “install” and “connect” may have a general meaning, e.g., fixed connection, detachable connection or integral connection, or direct connection or indirect connection via an intermediate component, or communication between two components. The meanings of these words may be understood by a person skilled in the art according to the practical need.

In the above description, the features, structures, materials or characteristics may be combined in any embodiment or embodiments in an appropriate manner.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. An asymmetric transmission structure, comprising a transparent basal layer and a grating layer arranged at a side of the transparent basal layer, wherein the grating layer comprises a plurality of structural members arranged periodically and spaced apart from each other in a direction parallel to the transparent basal layer, each structural member is provided with a first surface and a second surface, the second surface is attached to the transparent basal layer, and an area of the first surface is not larger than an area of the second surface.

2. The asymmetric transmission structure according to claim 1, wherein the structural members comprise at least one kind of cylindrical structural members and truncated-cone-like structural members.

3. The asymmetric transmission structure according to claim 2, wherein the plurality of structural members is arranged at the side of the transparent basal member in at least one of a two-dimensional simple-square Bravais lattice and a two-dimensional simple-hexagon Bravais lattice.

4. The asymmetric transmission structure according to claim 3, wherein the two-dimensional simple-square Bravais lattice belongs to one of point groups C₄ and C₄ᵥ.

5. The asymmetric transmission structure according to claim 3, wherein the two-dimensional simple-hexagon Bravais lattice belongs to one of point groups C₃, C₃ᵥ, C₆ and C₆ᵥ.

6. The asymmetric transmission structure according to claim 1, wherein an arrangement period of the structural members ranges from 300 nm to 1000 nm.

7. The asymmetric transmission structure according to claim 6, wherein the arrangement period is a sum of a diameter of the second surface of the structural member and a distance between two adjacent structural members.

8. The asymmetric transmission structure according to claim 7, wherein the arrangement period ranges from 500 nm to 700 nm.

9. The asymmetric transmission structure according to claim 1, wherein the transparent basal layer is transparent to visible light, and the structural member is nontransparent to the visible light.

10. The asymmetric transmission structure according to claim 9, wherein the structural member is made of a metal material.

11. The asymmetric transmission structure according to claim 10, wherein the metal material is gold, silver or aluminum, or a combination thereof.

12. The asymmetric transmission structure according to claim 1, wherein the structural member is a truncated-cone-like structural member, a diameter d1 of the first surface and a diameter d2 of the second surface of the structural member each ranges from 0 nm to 800 nm, and a shortest distance h between a center of the first surface and a center of the second surface ranges from 0 nm to 500 nm.

13. The asymmetric transmission structure according to claim 12, wherein the diameter d1 of the first surface of the structural member ranges from 100 nm to 300 nm, the diameter d2 of the second surface of the structural member ranges from 200 nm to 450 nm, and the shortest distance h between the center of the first surface and the center of the second surface ranges from 100 nm to 200 nm.

14. The asymmetric transmission structure according to claim 1, wherein a refractive index of the transparent basal layer ranges from 1.4 to 2.0.

15. A semiconductor optical device, comprising the asymmetric transmission structure according to claim 1.

16. The semiconductor optical device according to claim 15, wherein the structural members comprise at least one kind of cylindrical structural members and truncated-cone-like structural members.

17. The semiconductor optical device according to claim 16, wherein the plurality of structural members is arranged at the side of the transparent basal member in at least one of a two-dimensional simple-square Bravais lattice and a two-dimensional simple-hexagon Bravais lattice.

18. The semiconductor optical device according to claim 15, wherein an arrangement period of the structural members ranges from 300 nm to 1000 nm.

19. The semiconductor optical device according to claim 15, wherein the structural member is a truncated-cone-like structural member, a diameter d1 of the first surface and a diameter d2 of the second surface of the structural member each ranges from 0 nm to 800 nm, and a shortest distance h between a center of the first surface and a center of the second surface ranges from 0 nm to 500 nm.

20. The semiconductor optical device according to claim 19, wherein the diameter d1 of the first surface of the structural member ranges from 100 nm to 300 nm, the diameter d2 of the second surface of the structural member ranges from 200 nm to 450 nm, and the shortest distance h between the center of the first surface and the center of the second surface ranges from 100 nm to 200 nm.
